(19) United States
(12) Patent Application Publication
(10) Pub. No.: US 2002/0162937 A1
(43) Pub. Date: Nov. 7, 2002

(54) Audio electrical or audio electronic equipment or component thereof

(75) Inventors: Karl Sebert, Kirchheim / Teck (DE); Ulrich Madeheim, Wernau (DE)

Correspondence Address: BROWDY AND NEIMARK, P.L.L.C., 624 NINTH STREET, NW, SUITE 300, WASHINGTON, DC, 20001-5303, US

(73) Assignee: Sebert Schwingungstechnik GmbH, Kirchheim (DE)

(21) Appl. No.: 09/918,720

(22) Filed: Aug. 1, 2001

(30) Foreign Application Priority Data
Aug. 2, 2000 (DE) 100 37 594.4

(51) Int. Cl. F16M 13/00

(52) U.S. Cl. 248/618; 248/560

(57) ABSTRACT

Proposed is a piece of audio electrical or audio electronic equipment or component thereof, having at least one combined spring-damper element (14) for supporting the equipment (13) or its component on a surface (15) in such a way that the resonance frequency of the spring-damper element (14) is below 20 Hz. The defined natural frequency of the support outside of self-starting vibrations along with the damping results in a significantly improved sound quality while protecting against external influences, such as structure-borne noise and airborne noise, as well as against self-starting vibrations of the piece of equipment, by damping them.

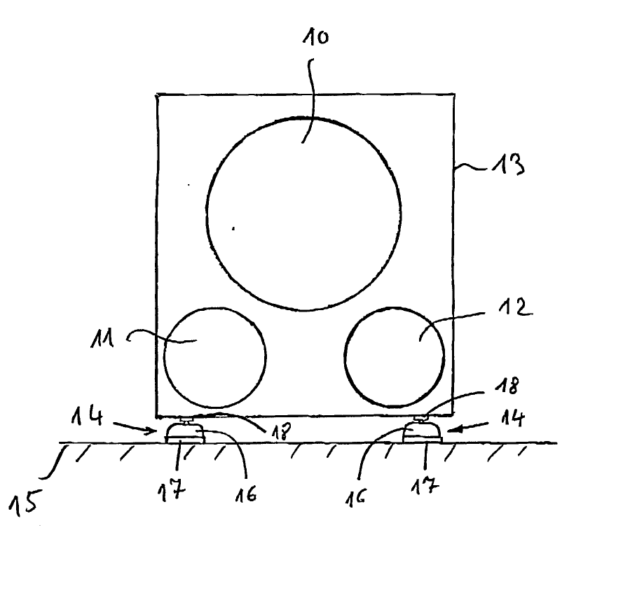

The present invention is concerned with a piece of audio electrical or audio electronic equipment or component thereof having an elastic support to soften hard shocks that could result in damage to the equipment. It is known, for example, to provide tape drives, record players, CD players or the like with an elastic support. It is furthermore known to provide the casings of such equipment with feet of rubber-like material or rubber-like intermediate layers, also in order to attain a soft support. Feet of this type, however, are not capable of damping natural vibrations of such equipment and components, or preventing vibrations from being transmitted from the surface on which the equipment or components are sitting. Vibrations of this type are undesirable, in particular because they impact the sound quality of the given piece of equipment.

It is an object of the present invention to improve the sound quality of audio electrical or audio electronic equipment or components thereof.

This object is met according to the invention with a piece of audio electrical or audio electronic equipment or component thereof having at least one combined spring-damper element to support the piece of equipment or its component on a surface in such a way that the resonance frequency of the spring-damper element is below 20 Hz.

Combined spring-damper elements are superbly suitable for damping vibrations coming from the surface on which the piece of equipment or component is sitting, or vibrations of the piece of equipment or its components, and thus for contributing significantly to improving the sound quality. Keeping the resonance frequency of the spring-damper element below 20 Hz ensures that all undesirable vibrations in the usual listening range above 20 Hz are damped. By supporting the given piece of equipment or component thereof in a simple manner on such a spring-damper element, a significant contribution to an improved sound quality can be made easily and cost effectively. Moreover, spring-damper elements of this type can be manufactured in a simple and cost effective manner.

The measures listed in the subclaims permit advantageous further developments and improvements of the piece of equipment specified in claim 1.

The support will advantageously be on a plurality of spring-damper elements, preferably on four such elements.

Spring-damper elements with elastic and/or damping properties that are essentially identical in all directions permit the most even damping and damping of vibrations that can have any random vibration direction.

Particularly suitable as a spring-damper element is a wire rope damper or wire mesh damper, which can be manufactured in a particularly simple and cost effective manner in a small size.

An embodiment of the invention is shown in the drawing and explained in more detail in the following description. The single figure shows a side view of a loudspeaker assembly supported on spring-damper elements.

The single figure shows a loudspeaker housing 13 equipped with three loudspeakers 10-12 that is supported on a surface 15 by means of four spring-damper elements 14 on its underside. The spring-damper elements 14 may be fixed on the loudspeaker housing 13 and/or on the surface 15, or arranged loosely. Of course, of the four spring-damper elements 14 only two are visible in the side view.

In the embodiment the spring-damper elements 14 are designed as wire mesh dampers, i.e., they have a dome-shaped wire mesh 16 that is fixed at its circumference to a lower holder 17, e.g., clamped-on, and that has in its center a second upper holder 18 that is supported on the loudspeaker housing 13 or fixed on the same. The elastic properties and damping properties may be determined with the choice of wire mesh 16, i.e., wire strength, wire spacing, wire orientation and the like. They are selected in such a way that the spring-damper elements 14 have a resonance frequency below 20 Hz, which is a frequency that does not have any effect on the audio frequency range.

The desired damping effect is brought about by friction of the wires of the wire mesh 16 against one another. This prevents interfering vibrations from being transferred from the surface 15 to the loudspeaker housing 13 and thus to the loudspeakers 10 through 12. Moreover, vibrations of the loudspeaker housing 13 that are self-generated or transferred by airborne sound are also damped. Damping these interfering frequencies prevents them from being transferred to the desired audio frequencies or from mixing with or changing the same, with the result that the listening quality is raised significantly. Also, the undesirable power line hum is effectively damped in this manner.

The invention is not limited to the damped support of loudspeakers or loudspeaker housings, of course, instead it is applicable to all pieces of audio electrical or audio electronic equipment, for example CD-players, record players, amplifiers, loudspeakers, DVD players, video recorders, television sets, tape players or the like. Moreover, as an alternative to or in addition to reducing the impact of mechanical vibrations, only certain component groups or elements of such equipment may be supported, for example drive assemblies, power supply units, boards, capacitors, or the like.

Instead of wire-mesh based spring-damper elements 14, other elements of this type, preferably with identical or similar elastic properties, may be used as an alternative. It is also possible, for example, to use wire rope dampers, as they are described, for example in DE-A-19947794. In these wire rope dampers, wire rope elements serve to dampen and cushion against vibrations, and the damping is again based on the friction of the individual wires of the wire ropes against one another.

The defined natural frequency of the support outside of self-starting vibrations and the damping result in a greatly improved operation and significantly improved sound quality.

What is claimed is:

1. A piece of audio electrical or audio electronic equipment or component thereof, having at least one combined spring-damper element (14) for supporting the piece of equipment (13) or its component on a surface (15) in such a way that the resonance frequency of the spring-damper element (14) is below 20 Hz.

2. A piece of equipment or component according to claim 1, characterized in that it is supported on a plurality of spring-damper elements (14).

3. A piece of equipment or component according to claim 1 or 2, characterized in that at least one spring-damper element (14) has elastic and/or damping properties that are essentially identical in all directions.

4. A piece of equipment or component according to any of the above claims, characterized in that at least one spring-damper element (14) is designed in the form of a wire rope damper or wire mesh damper.

5. A piece of equipment or component according to any of the above claims, characterized in that the resonance frequency of the spring-damper element is below 8 Hz.
